(19) United States
(12) Patent Application Publication
(10) Pub. No.: US 2006/0126650 A1
(43) Pub. Date: Jun. 15, 2006

(54) Method and apparatus for bridging devices having interfaces of same layer

(76) Inventors: Chul Hyung Zhung, Daejeon-city (KR); Hak Suh Kim, Daejeon-city (KR); Byung Jun Ahn, Daejeon-city (KR); Hae Won Jung, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/298,762

(22) Filed: Dec. 9, 2005

(30) Foreign Application Priority Data
Dec. 15, 2004 (KR) 10-2004-0106495
Jul. 26, 2005 (KR) 10-2005-0067819

(51) Int. Cl. H04L 12/26; H04L 12/56; H04L 1/00; H04L 12/28

(52) U.S. Cl. 370/401; 370/229

(57) ABSTRACT

A method and apparatus for arbitrating control signals to bridge an SPI-3 interface recommended by the optical internetworking forum (OIF), between devices in an identical layer using the SPI-3 interface are provided. According to the method and apparatus, a bridging apparatus which performs the role of a link layer device between devices in a physical layer using the SPI-3 interface, and the role of a physical layer device between devices in a link layer devices, is disposed so that control signals do not collide with each other when the SPI-3 interface is directly connected between devices in the identical layer. By doing so, data transmission and reception through exchange of control signals between even devices in the same layer is enabled without modification of the conventional devices.

### CROSS-REFERENCE TO RELATED PATENT APPLICATIONS

This application claims the benefit of Korean Patent Application Nos. 10-2004-0106495, filed on Dec. 15, 2004 and 10-2005-0067819, filed on Jul. 26, 2005 in the Korean Intellectual Property Office, the disclosures of which are incorporated herein in their entirety by reference.

### BACKGROUND OF THE INVENTION

1. Field of the Invention

The present invention relates to an interface bridging method, and more particularly, to a method and apparatus for relaying a control signal so that interfaces between devices in an identical layer can be bridged by using a hardware logic.

2. Description of the Related Art

The Optical Internetworking Forum (OIF) recommends a system packet interface level 3 (SPI-3) defining interface, between synchronous optical networking (SONET)/SDH physical layer and link layer. The SPI-3 is an interface technology capable of transmitting and receiving a maximum of a 2.5 Gbit signal when a 32-bit data bus operates at 104 MHz. Since interface control signals are managed differently depending on the layer of a device according to the SPI-3, if devices of an identical layer are connected to each other, control signals will collide with each other. Accordingly, an interface capable of communicating data between devices of an identical layer may be needed in a variety of types of applications that desire to interoperate devices of an identical layer, such as packet monitoring and mirroring technologies in physical layer devices, and multi-stage link layer device processing technologies to increase processing capacity in link layer devices. However, the SPI-3 recommended by the OIF defines only networking between a physical layer device and a link layer device, and does not provide interface between devices of an identical layer, that is, interface between link layer devices or between physical layer devices. In addition, commercial devices for the interface have not been introduced.

### SUMMARY OF THE INVENTION

The present invention provides a method and apparatus enabling data communication between devices of an identical layer by using conventional commercial devices.

According to an aspect of the present invention, there is provided an apparatus bridging physical layer devices including: a storage unit receiving a data packet from a device at a transmission side and storing the data packet; a reception control unit generating a reception driving signal as a signal indicating that the storage unit is in a state capable of receiving a data packet, in order for the device at the transmission side to transmit the data packet, and transmitting the reception driving signal to the device at the transmission side; and a transmission control unit generating a transmission driving signal in order for the device at the reception side to receive the data packet, if the state signal indicating the state capable of receiving the data packet from the device at the reception side, is received, and transmitting the transmission driving signal to the device at the reception side.

According to another aspect of the present invention, there is provided a method for bridging physical layer devices in an apparatus relaying a control signal, the method including: if there is a storage space equal to or greater than a predetermined threshold value, generating a reception driving signal in order for a device at the transmittion side to transmit a data packet, and transmitting the signal to the device at the reception side; receiving and storing a data packet transmitted by the device at the transmission side receiving the reception driving signal; receiving a state signal indicating that the device at the reception side is in a state capable of receiving a data packet, from the device at the reception side; if the state signal is received, generating a transmission driving signal in order for the device at the reception side to receive the data packet, and transmitting the signal to the device at the reception side; and transmitting the data packet to the device at the reception side.

According to still another aspect of the present invention, there is provided a apparatus bridging link layer devices including: a storage unit receiving a data packet from a device at a transmission side and storing the data packet; a reception control unit generating a state signal indicating that the storage unit is in a state capable of receiving a data packet, and transmitting the state signal to the device at the transmission side, and receiving a transmission driving signal enabling the data packet to be received, from the device at the transmission side receiving the state signal; and a transmission control unit controlling so that the data packet stored in the storage unit is transmitted to the device at the reception side if a reception driving signal enabling the data packet to be transmitted, from the device at the reception side is received.

According to yet still another aspect of the present invention, there is provided a method for bridging link layer devices in an apparatus relaying a control signal, the method including: generating a state, signal indicating a state capable of receiving a data packet and transmitting the state signal to a device at a transmission side; receiving a transmission driving signal enabling a data packet to be received, from the device at the transmission side; receiving the data packet from the device at the transmission side and storing the data packet; and if a reception driving signal enabling a data packet to be transmitted, from a device at a reception side is received, transmitting the data packet to the device at the reception side.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an environment to which an SPI-3 interface is applied;

FIG. 2 illustrates signal lines for an SPI-3 interface between a physical layer device and a link layer device;

FIG. 3 is a diagram explaining SPI-3 control signals managed differently in a physical layer device and a control layer device, respectively;

FIG. 4 is a block diagram of the structure of a physical layer bridge disposed between physical layer devices and relaying control signals according to a preferred embodiment of the present invention; and

FIG. 5 is a block diagram of the structure of a link layer bridge disposed between link layer devices and relaying control signals according to a preferred embodiment of the present invention.

### DETAILED DESCRIPTION OF THE INVENTION

The present invention will now be described more fully with reference to the accompanying drawings, in which exemplary embodiments of the invention are shown. In all embodiments hereinafter, a physical layer device will be explained with an example of a 4-port OC-12 packet of SONET (POS) physical layer device processing 4 external optical signals (SONET OC-12).

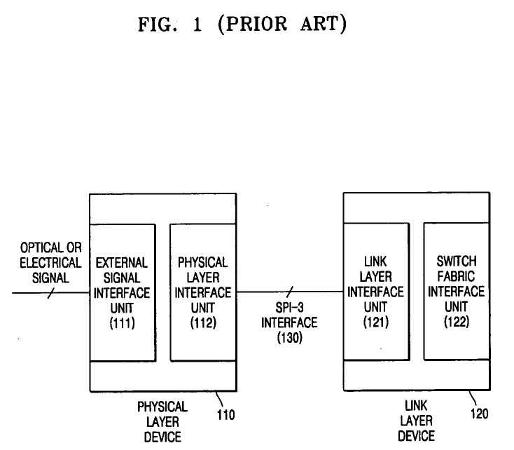

FIG. 1 is a block diagram of an environment to which an SPI-3 interface is applied.

As shown in FIG. 1, a physical layer device 110 includes an external signal interface unit 111 interoperating with an external network through an optical or electrical signal, and a physical layer interface unit 112 to which the SPI-3 interface is applied. A link layer device 120 includes a link layer interface unit 121 to which the SPI-3 interface is applied, and a switch fabric interface unit 122.

In transmission of a signal from a physical layer to a link layer, an external signal (for example, a SONET signal or an Ethernet signal) in the physical layer device 110 is processed in the external signal interface unit 111 of the physical layer, and is transmitted to the link layer that is an upper layer, through the SPI-3 interface 130. Then, in the link layer device 120, the data transmitted through the SPI-3 interface 130 from the physical layer device 110 is processed and then transmitted to the switch fabric interface unit 122. Meanwhile, data flow from the link layer to the physical layer is processed in the reverse order. This is an ordinary standard for the SPI-3 interface layer proposed by the OIF.

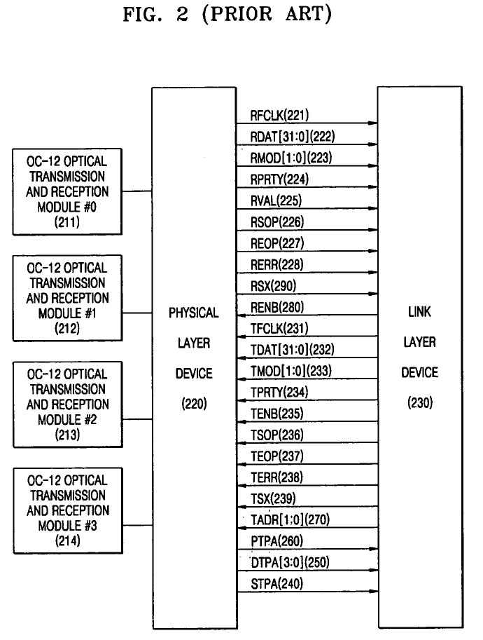

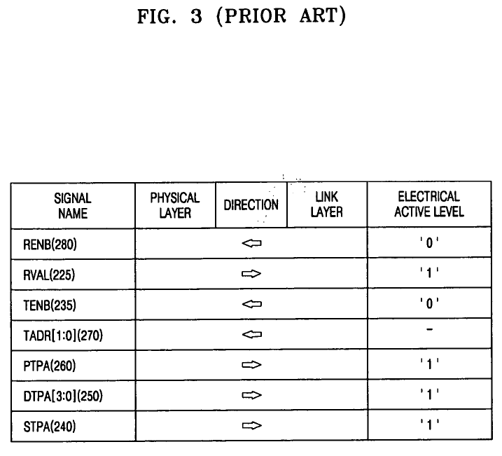

FIG. 2 illustrates signal lines for an SPI-3, interface between a physical layer device and a link layer device. FIG. 3 is a diagram explaining SPI-3 control signals managed differently in a physical layer device and a control layer device, respectively.

First, signal processing in the direction from the physical layer device 220 to the link layer device 230 will now be explained. Four 622 Mbit level optical signals OC-12 are converted into electrical signals in optical transmission and reception modules 211 through 214, and then are bridged to electrical signals in the physical layer device 220. The physical layer device 220 processes the 622 Mbit level electrical signals and then transmits packet data to the link layer device 230 through the SPI-3 interface. As shown in FIG. 2, the SPI-3 interface signals in this direction include RFCLK 221, RDAT[31:0] 222, RMOD[1:0] 223, RPRTY 224, RVAL 225, RSOP 225, REOP 227, RERR 228, RSX 290, and RENB 280. Especially among these signals, the RENB 280 and RVAL 225 are signals that are managed differently in the physical layer interface and the link layer interface, respectively. The RENB signal 280 is generated in the link layer device 230 and provided to the physical layer device 220, and indicates whether or not there is a space to process packet data in the link layer. Normally, the RENB signal 280 is providing information on the state of a data storage FIFO of the link layer device 230. The RVAL signal 225 is a signal indicating that packet data is a normally processed packet data when the physical layer device 200 transmits the packet data, and indicating normally processed data when an electrical signal level is 1.

Meanwhile, signal processing in the direction from the link layer device 230 to the physical layer device 220 is performed in the reverse order, and a control signal is transmitted mainly from the link layer device 230 to the physical layer device through the SPI-3 interface. The SPI-3 interface signal in this direction include TFCLK 231, TDAT[31:0] 232, TMOD[1:0] 233, TPRTY 234, TENB 235, TSOP 236, TEOP 238, TSX 239, TADR[1:0] 270, PTPA 260, DTPA[3:0] 250, and STPA 240. Especially among these signals, the TENB 235, TADR[1:0] 270, PTPA 260, DTPA[3:0] 250, and STPA 240 are signals that are managed differently in the physical layer and the link layer, respectively. The TENB signal 235 is a signal indicating that packet data is normally processed packet data when the packet data is transmitted in the link layer device 230, and indicating normally processed data when an electrical signal level is 0. The TADR[1:0] 270, PTPA 260, DTPA[3:0] 250, and STPA 240 are signals indicating whether or not there is a space to process packet data in the physical layer device 220 when packet data is transmitted from the link layer device 230 to the physical layer device 220, and generally inquire the state of the data storage FIFO in the physical layer. The TADR[1:0] signal 270 is generated in the link layer device 230 and transmitted to the physical layer device 220, and as a response to this, the physical layer device 220 generates and transmits the PTPA 260. The DTPA[3:0] signal 250 is automatically generated in the physical layer device 220 in order to indicate the state of each data storage FIFO to a corresponding link port. The TDAT[7:0] 232 and TSX 239 are signals for the link layer device 230 to select a predetermined link port and to identify the state of the data storage FIFO of the link port. In response to these, the physical layer device 220 generates and transmits the STPA signal 240.

As shown in FIG. 3, the RENB 280, RVAL 225, TENB 235, TADR[1:0] 270, PTPA 260, DTPA 250, and STPA 240 are signals that are managed differently according to the layer of a device, and signals for the unique purpose of any one of the physical layer device and the link layer device. Even signals performing similar functions, for example, the TENB 235 and the RVAL 225, have electrical activation levels different to each other. Accordingly, if devices of an identical layer are connected directly by the SPI-3 interface signal line and used, collision of control signals will occur.

More details in relation to other SPI-3 interface signal lines and structures are included in OIF-SPI3-01.0 recommendation and will be omitted here because those are beyond the scope of the present invention.

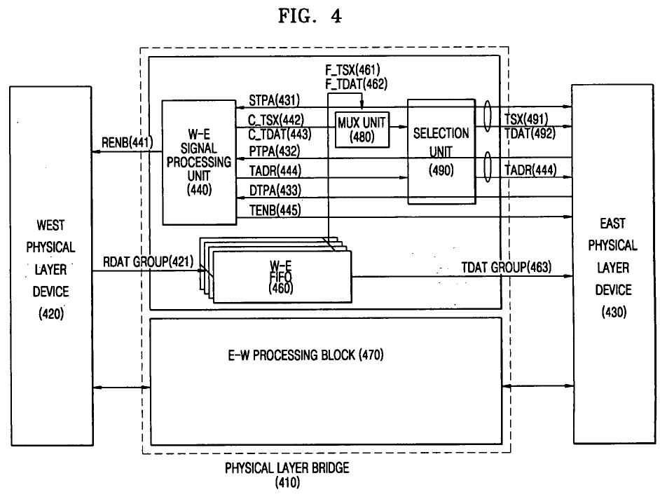

FIG. 4 is a block diagram of the structure of a physical layer bridge disposed between physical layer devices and relaying control signals according to a preferred embodiment of the present invention. A physical layer device to the left of the physical layer bridge 410 according to the present invention will be referred to as a west physical layer device 420, and a physical layer bridge to the right of the physical layer bridge 410 will be referred to as an east physical layer device 430. Hereinafter, only a signal flow from the left to the right, that is, the signal flow in the direction (W-E) from the west physical layer device 420 to the east physical layer device 430 will be described. Since the signal system in the direction from the right to the left (E-W) processed by an E-W processing block 470 is identical to that of the W-E direction except that only directions are opposite, the explanation will be omitted.

As shown in FIG. 4, the physical layer bridge 410 includes a W-E FIFO 460 and a W-E signal processing unit 440. The W-E FIFO 460 receives and stores a data packet from the west physical layer device 420, and transmits a data packet to the east physical layer device 430. The W-E signal processing unit 440 generates and transmits to the west physical layer device 420, a RENB signal 441 to indicate that the W-E FIFO 460 is in a state in which the W-E FIFO 460 can receive a packet, and receives from the east physical layer device 430, an xTPA signal (STPA, PTPA, DTPA) indicating whether or not a data packet can be received. If according to the result of the reception it is determined that a data packet can be received, the W-E signal processing unit 440 generates and transmits to the east physical layer device 430, a TENB signal 445 that is a data transmission driving signal.

The entire flow of a control signal to transmit a data packet from the west physical layer device 420 to the east physical layer device 430 will now be explained. First, xTPA signals to inquire whether or not the east physical layer device 430 that is a reception side can receive a packet will be briefly explained and then, the signal flow between the west physical layer device 420 and the physical layer bridge 410 and the signal flow between the physical layer bridge 410 and the east physical layer device 430 will be explained. Finally, the process of generating and processing signals in the physical layer device 430 in relation to the xTPA signals will be explained in detail.

The W-E signal processing unit 440 uses the STPA 431, PTPA 432, and DTPA 433 signals in order to identify the state of a reception FIFO in the east physical layer device 430, and xTPA is a term collectively indicating these signals. Though commercial device products are not generally using all of these xTPA signals, at least one or more signals among these are provided. Accordingly, the physical layer bridge 410 according to the present invention should monitor all xTPA signals. Selection of these signals is performed in a selection unit 490 by an external command according to an operation method in a commercial device, and this selection can be processed by hardware or can be performed by a control command of a processor.

First, in respect of the STPA signal 431, 0˜3 that are OC012 4 port numbers are generated in a round-robin method in the W-E signal processing unit 440 of the physical layer bridge 410 and the port numbers are loaded in the low-order 8 bits of the TDAT 492, and transmitted together with the TSX signal 491 to the east physical layer device 430. By doing so, the state of the FIFO of the east physical layer device 430 in relation to each corresponding port is inquired. Then, the east physical layer device 430 provides the Tx FIFO state in relation to the corresponding port as the STPA 431 signal.

Next, in respect of the PTPA signal 432, if the W-E signal processing unit 440 generates and transmits to the east physical layer device 430, a TADR[1:0] signal 444 indicating the port addresses of 0˜3 by a round-robin method, the east physical layer device 430 receiving the signal 444 determines whether or not there is a predetermined storage space that can receive a data packet, in the Tx FIFO of a port corresponding to the TADR[1:0] signal 444, and transmits the result as the PTPA signal 432.

The DTPA[3:0] signal 433 is generated in the east physical layer device 430 to indicate whether or not there is a storage space capable of receiving a data packet, in the Tx FIFO corresponding to each port, and transmitted directly to the physical layer bridge 410. Information on the port 0 through port 4 is generated as DTPA[0] through DTPA[3], respectively, and transmitted.

Next, the data flow form the west physical layer device 420 to the physical layer bridge 410 will now be explained. In the physical layer bridge 410, data packets transmitted by the west physical layer device 420 are received through RDAT group signals 421, and here the RDAT group indicate RDAT[31:0], RMOD[1:0], RPRTY, RSOP, REOP, RERR, and RSX. At this time, by setting an upper layer threshold in relation to whether or not the W-E FIFO 460 has a buffer capacity capable of receiving data, the flow of packet data can be controlled, and the upper layer threshold here can be determined arbitrarily. For example, when a 512K×32-bit FIFO is used and a jumbo packet is considered, by generating the RENB signal 441 which prohibits reception when the buffer capacity is less than 1K×32 bits and permits reception when the buffer capacity is greater than that, the flow of the RDAT group 421 can be controlled.

Meanwhile, the signal flow from the physical layer bridge 410 to the east physical layer device 430 will now be explained. If the xTPA signal is in logic level 1, that is, if the east physical layer device 430 informs the physical layer bridge 410 through the xTPA that data can be received, and if there is data in the W-E FIFO 460, the physical layer bridge 410 transmits TDAT[31:0] that is a data packet signal, the TDAT group bus 463, and the TENB signal 445 that is a data transmission driving signal, to the east physical layer device 430. Here, the TDAT group indicate TMOD, TPRTY, TSOP, TEOP, TERR, and TSX.

Accordingly, in the physical layer bridge 410 the RENB signal 441 is transmitted to the west physical layer device 420 based on the upper layer threshold in relation to the buffer capacity of the W-E FIFO 460, and the west physical layer device 420 receiving the RENB signal 441, transmits through the RDAT group bus 421 to the physical layer bridge 410, a data packet if there is the data packet to be transmitted and the RENB signal 441, is in logic level 0. The physical layer bridge 410 stores the received data packet in the W-E FIFO 460 and then, receives the xTPA of the east physical layer device 430. If the value of the xTPA is 1 indicating that reception is possible, the physical layer bridge 410 transmits TDAT[31:0] 492 and the TDAT group bus 463 together with the TENB 445 that is a transmission data enable signal, to the east physical layer device 430.

Since the xTPA signal processing methods are different to each other as described above, the xTPA signal processing method should be able to be selected according to a method provided by the physical layer device. The process of generating and processing signals in the physical layer bridge 410 according to the present invention will now be explained in more detail in relation to each of the xPTA signals.

First, in case of the STPA method, if the west physical layer device 420 receiving the RENB signal 441 transmits the RDAT group bus signal 421, the physical layer bridge 410 receives the signal 421 and in the RSX position, stores the signal 421 in the W-E FIFO 460 corresponding to port addresses indicated by the low-order 8 bits of RDAT[31:0], that is, RDAT[7:0], by using the RVAL signal as an enable signal. Next, F_TDAT 462 and F_TSX 461, corresponding to the RDAT and RSX, respectively, from the W-E FIFO 460 are input to a MUX unit 480 and also, C_TSX 442 and C_TDAT 443 signals that are generated in the W-E signal processing unit 440 by itself in order to inquire the state of the east physical layer device 430, and signals specifying the FIFO addresses of the east physical layer device 430. Then, the MUX unit 480 selects one of these signals, and transmits the selected signal as the TSX signal 491 and the low-order 8 bits of TDAT[31:0] 492, to the east physical layer device 430. The east physical layer device 430 receiving the TSX signal 491 and the low-order 8 bits of the TDAT[31:0], that is, the TDAT[7:0], transmits the STPA signal 431 in relation to a port corresponding to the received signals. In the physical layer bridge 410, the FIFO state of the address corresponding to the TDAT[7:0], that is, the corresponding port, is stored in a register, and if a next packet is received, the register is read and it is determined whether or not the corresponding port can receive a packet. If the register value is 1 indicating that reception is possible, packet data is transmitted. If the register value is 0, the C_TSX signal 442 and C_TDAT[7:0] 443 are generated by the physical layer bridge 410 and the states of FlFOs of the physical layer device 430 are monitored in a round-robin method and if the FIFOs come into a state that reception is possible, packet data is transmitted. By doing so, the packet data transmitted from the west physical layer device 420 can be transferred transparently to the east physical layer device 430.

Next, in case that the PTPA method is used, the process in which the physical layer bridge 410 receives a data packet from the west physical layer device 420 is identical to that of the STPA method described above, except a process of transmitting the packet data to the east physical layer device 430. The W-E signal processing unit 440 by itself generates and transmits to the east physical layer device 430, port addresses corresponding to the TADR[1:0] signal, that is, 0˜3, and the east physical layer device 430 receiving the addresses, generates and transmits to the W-E signal processing unit 440, the PTPA 432 indicating the state of each corresponding port. The W-E signal processing unit 440 receiving the PTPA 432, stores the FIFO state of the corresponding port in a register. If a packet is transmitted from the west physical layer device 420, this register is read and it is confirmed whether or not the corresponding port can receive the packet. If the value stored in the register is 1 indicating that reception is possible, the packet data is transmitted.

Finally, in case that the DTPA method is used, the process in which the physical layer bridge 410 receives a data packet from the west physical layer device 420 is identical, except a process of transmitting the packet data to the east physical layer device 430. Even if there is no request signal, the east physical layer device 430 generates and transmits to the W-E signal processing unit 440, DTPA[3:0] indicating the FIFO state of the east physical layer device 430 and the W-E signal processing unit 440 stores a value extracted from the received DTPA[3:0] in a state register. If a packet from the west physical layer device 420 is received, this register is read and it is confirmed whether or not the FIFO of the corresponding port can receive the packet. If the stored value is 1 indicating that reception is possible, the packet data is transmitted.

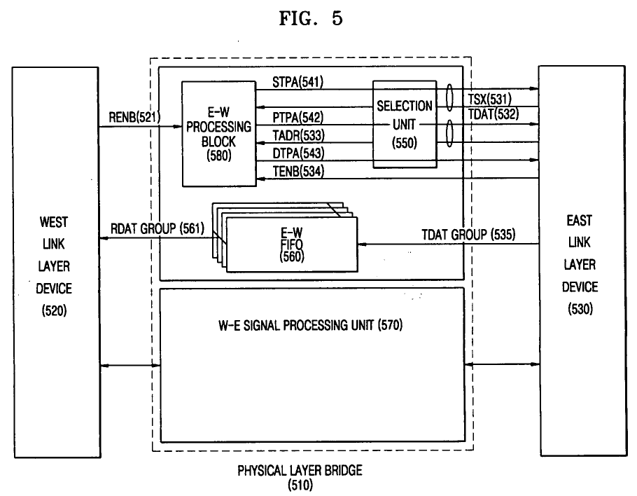

FIG. 5 is a block diagram of the structure of a link layer bridge disposed between link layer devices and relaying control signals according to a preferred embodiment of the present invention.

Hereinafter, a link layer device to the left of the link layer bridge 510 according to the present invention will be referred to as a west link layer device 520, and a link layer device to the right of the link, layer bridge 510 will be referred to as an east link layer device 53. Also, only the case wherein data packet is transmitted from the right-hand side to the left-hand side will be explained and the explanation of the opposite direction case processed by a W-E processing block 570 will be omitted because only the directions are different and the signal systems are identical.

The link layer bridge 510 should process a control signal received from a link layer device, in the same manner as the physical layer device processes the control signal, and the link layer bridge 510 should generate xTPA signals (STPA, PTPA, DTPA) in particular. In the present embodiment, it is assumed that the link layer bridge 510 interoperates with 4-port link layer devices.

As shown in FIG. 5, the link layer bridge 510 includes an E-W FIFO 560 storing data received from a link layer device, and an E-W signal processing unit 580 generating a signal responding to a control signal received from a link layer device.

In order to notify the state of the E-W FIFO 560 of the link layer bridge 510, the E-W signal processing unit 580 generates xTPA signals (STPA, PTPA, DTPA) that are SPI-3 interface control signals. Selection of these signals is performed in a selection unit 490 by an external command according to an operation method in a commercial device, and this selection can be processed by hardware or can be performed by a control command of a processor.

First, in respect of the STPA signal 541, in the link layer bridge 510, TSX signal 531 and TDAT[31:0] signal 531 from the east link layer device 530 are received, and then, the storage space of the E-W FIFO 560 corresponding to the port numbers indicated by the low-order 8 bits of the TDAT[31:0], that is, TDAT[7:0], is identified. If a packet can be received, the value of the STPA signal 541 set to 1 is transmitted and if the storage space is insufficient and reception is impossible, the value of the STPA signal 541 set to 0 is transmitted so that the flow of the packet data can be controlled.

Next, in case of the PTPA signal 542, the link layer bridge 510 receives TADR[1:0] signal 533 from the east link layer device 530, and identifies the storage space of the corresponding E-W FIFO 560. If a packet can be received, the value of the PTPA signal 542 set to 1 is transmitted and if the storage space is insufficient and reception is impossible, the value of the PTPA signal 542 set to 0 is transmitted so that the flow of the packet data can be controlled.

Finally, in case of the DTPA[3:0] signal 543, even when there is no separate request signal from the link layer bridge 510, the states of the ports 0 through 4 of the E-W FIFO 560 are generated as DTPA[0], DTPA[1], DTPA[2] and DTPA[3], respectively, and transmitted to the east link layer device 530.

The signal flow from the east link layer device 530 to the link layer bridge 510 will now be explained. The link layer bridge 510 receives signals from the east link layer device 530 through the TDAT[31:0] 532 and the TDAT group bus 535. At this time, as described above, whether or the E-W FIFO 560 is in a state in which packet data can be received can be known through the xTPA signal and according to the state, the flow of the packet data can be controlled.

The data flow from the link layer bridge 510 to the west link layer device 520 will now be explained. If the RENB signal 521 transmitted by the west link layer device 520 is in logical level 0, that is, if the west link layer device 520 is in a state in which data can be received, the link layer-bridge 510 checks the E-W FIFO 560, and if there is data stored, the link layer bridge 510 transmits the RDAT group bus signal 561 to the west link layer device 520.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the present invention a bridging apparatus which performs the role of a link layer device between devices in a physical layer and the role of a physical layer device between devices in a link layer devices, is disposed so that control signals do not collide with each other when the interface is directly connected between devices in the identical layer. By doing so, data transmission and reception through exchange of control signals between even devices in the same layer is enabled without modification of the conventional devices.

What is claimed is:

1. An apparatus bridging physical layer devices comprising:
a storage unit receiving a data packet from a device at a transmission side and storing the data packet;
a reception control unit generating a reception driving signal as a signal indicating that the storage unit is in a state capable of receiving a data packet, in order for the device at the transmission side to transmit the data packet, and transmitting the reception driving signal to the device at the transmission side; and
a transmission control unit generating a transmission driving signal in order for the device at the reception side to receive the data packet, if the state signal indicating the state capable of receiving the data packet from the device at the reception side, is received, and transmitting the transmission driving signal to the device at the reception side.

2. The apparatus of claim 1, wherein the state signal is transmitted by the device at the reception side as a response to a state information request signal inquiring the device at the reception side whether or not the device at the reception side is in a state capable of receiving a data packet, and transmitted to the device at the reception side.

3. The apparatus of claim 1, wherein the state signal is automatically generated and transmitted by the reception side even though there is no signal inquiring whether or not the device at the reception side is in a state capable of receiving a data packet.

4. The apparatus of claim 2, wherein there are at least two or more of the state information request signals, and the apparatus further comprises a selection unit selecting one among the two or more state information request signals.

5. A method for bridging physical layer devices in an apparatus relaying a control signal, the method comprising:
if there is a storage space equal to or greater than a predetermined threshold value, generating a reception driving signal in order for a device at the transmission side to transmit a data packet, and transmitting the signal to the device at the reception side;
receiving and storing a data packet transmitted by the device at the transmission side;
receiving a state signal indicating that the device at the reception side is in a state capable of receiving a data packet, from the device at the reception side;
if the state signal is received, generating a transmission driving signal in order for the device at the reception side to receive the data packet, and transmitting the signal to the device at the reception side; and
transmitting the data packet to the device at the reception side.

6. The method of claim 5, wherein the state signal is transmitted by the device at the reception side as a response to a state information request signal inquiring whether or not the device at the reception side is in a state capable of receiving a data packet, and transmitted to the device at the reception side.

7. The method of claim 5, wherein the state signal is automatically generated and transmitted by the reception side even though there is no signal inquiring whether or not the device at the reception side is in a state capable of receiving a data packet.

8. The method of claim 6, wherein there are at least two or more of the state information request signals, and the method further comprises selecting one among the two or more state information request signals.

9. An apparatus bridging link layer devices comprising:
a storage unit receiving a data packet from a device at a transmission side and storing the data packet;
a reception control unit generating a state signal indicating that the storage unit is in a state capable of receiving a data packet, and transmitting the state signal to the device at the transmission side, and receiving a transmission driving signal enabling the data packet to be received, from the device at the transmission side; and
a transmission control unit controlling so that the data packet stored in the storage unit is transmitted to the device at the reception side if a reception driving signal enabling the data packet to be transmitted, from the device at the reception side is received.

10. The apparatus of claim 9, wherein the state signal is transmitted by the device at the reception side as a response to a state information request signal generated in order to inquire whether or not the device at the reception side is in a state capable of receiving a data packet, and transmitted to the device at the reception side.

11. The apparatus of claim 9, wherein the state signal is automatically generated and transmitted by the reception side even though there is no signal inquiring whether or not the device at the reception side is in a state capable of receiving a data packet.

12. The apparatus of claim 10, wherein there are at least two or more of the state information request signals, and the apparatus further comprises a selection unit selecting one among the two or more state information request signals.

13. A method for bridging link layer devices in an apparatus relaying a control signal, the method comprising:
generating a state signal indicating a state capable of receiving a data packet and transmitting the state signal to a device at a transmission side;
receiving a transmission driving signal enabling a data packet to be received, from the device at the transmission side;
receiving the data packet from the device at the transmission side and storing the data packet; and
if a reception driving signal enabling a data packet to be transmitted, from a device at a reception side is received, transmitting the data packet to the device at the reception side.

14. The method of claim 13, wherein the state signal is transmitted by the device at the reception side as a response to a state information request signal generated in order to inquire whether or not the device at the reception side is in a state capable of receiving a data packet, and transmitted to the device at the reception side.

15. The method of claim 13, wherein the state signal is automatically generated and transmitted by the reception side even though there is no signal inquiring whether or not the device at the reception side is in a state capable of receiving a data packet.

16. The method of claim 14, wherein there are at least two or more of the state information request signals, and the method further comprises selecting one among the two or more state information request signals.
